(19) United States
(12) Patent Application Publication
(10) Pub. No.: US 2018/0196679 A1
(43) Pub. Date: Jul. 12, 2018

(54) INITIALIZATION METHOD FOR USE IN I2C SYSTEM AND MASTER DEVICE

(71) Applicant: THOMSON Licensing, Issy-les-Moulineaux (FR)

(72) Inventor: Yi Qiang SUN, BEIJING (CN)

(21) Appl. No.: 15/740,557

(22) PCT Filed: Jun. 29, 2015
(86) PCT No.: PCT/CN2015/082650

§ 371 Date: Dec. 28, 2017

(51) Int. Cl. G06F 9/4401; G06F 13/42

(52) U.S. Cl. CPC G06F 9/4403; G06F 2213/0016; G06F 13/4291

(57) ABSTRACT

An initialization method for use in an 12C system is suggested. The 12C system comprises at least a master device and a slave device, which are interconnected via an 12C bus comprising a serial clock (SCL) line and a serial data (SDA) line. The method comprises: configuring an SCL pin, which is connected to the SCL line, of the master device to a General Purpose Input Output (GPIO) mode; informing the slave device to release the SDA line by sending a release signal from the SCL pin of the master and setting the 12C bus to a START condition by the master device. The present disclosure also provides a master device in the 12C system. The present disclosure can be applied to various 12C systems to improve the initialization process after abnormal termination of communication between a master device and a slave device.

### TECHNICAL FIELD

The present disclosure generally relates to the technical field of I2C system, and particularly to an initialization method for use in the I2C system and a master device in the I2C system.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

Inter-Integrated Circuit (I2C) technology is widely used for interconnection and communication between electronic devices due to its simple connection structure and high data exchange rate. FIG. 1 schematically shows an exemplary structure of an I2C system 100. As shown in FIG. 1, the I2C system 100 comprises a master device 110 and a plurality of slave devices 120-1, 120-2, and 120-3, which are interconnected via an I2C bus comprising a serial data (SDA) line and a serial clock (SCL) line. The master device 110 and slave devices 120-1, 120-2, and 120-3 are each assigned a unique address. During a communication process between the master device 110 and one of the slave devices, e.g., slave device 120-1, the master device 110 initializes the I2C bus and sends clock signals through the SCL line. Data signals are transmitted between the master device 110 and the slave device 120-1 through the SDA line. Although FIG. 1 only shows one master device and three slave devices, those skilled in the art will understand that there may be other numbers of master and/or slave devices in the I2C system. For example, there may be more than one master device and more or less than three slave devices. Meanwhile, the master device 110 may also act as a slave device and the slave device 120-1 may act as a master device in another communication process.

FIG. 2 schematically shows an exemplary communication process between the master device 110 and the slave device 120-1 in the I2C system 100 shown in FIG. 1. As shown in FIG. 2, the communication process begins with a START condition, in which the master device initializes the I2C bus by pulling the SDA line from a high level to a low level while the SCL line is at a high level. Then nine clock pulses are sent by the master device 110, in which clock pulses 1-7 are used for the address of the slave device 120-1, clock pulse 8 are used for a signal R/W indicating whether the operation to be performed is read or write, and clock pulse 9 is used for the slave device 120-1 sending an acknowledgement signal. Following the nine clock pulses are one or more groups of clock pulses, each group consisting of, e.g. nine clock pulses. For each of these clock pulse groups, clock pulses 1-8 are used for data transmission and clock pulse 9 is used for an acknowledgement signal. When the data transmission is completed, the I2C system 100 enters a STOP condition, in which the master device 110 sets the SCL line to the high level and the slave device release the SDA line by setting it to the high level to finish this communication process.

Normally, the above-described communication process can be performed properly. However, under certain undesired circumstances, such as accidental power down or malfunction of the master device 110, the communication process may be interrupted while the SDA line is at the low level, as indicated by a time point t_{A} in the figure. As the communication process stops abnormally, the slave device 120-1 cannot release the SDA line by setting it to the high level as in the normal STOP condition. This may cause the master device 110 unable to properly initialize the I2C bus again because the SDA line is already at the low level and thus the transition from the high level to the low level is impossible. An existing solution to this problem is to redo power cycle to let the slave device go back to normal status. However, a redundant power cycle has to be manually performed. For an I2C system involving user devices such as Set Top Boxes and TVs, this may cause very bad customer experiences.

### SUMMARY

According to a first aspect of the present disclosure, there is provided an initialization method for use in an I2C system. The I2C system comprises at least a master device and a slave device, which are interconnected via an I2C bus comprising a serial clock (SCL) line and a serial data (SDA) line. The method comprises: configuring an SCL pin, which is connected to the SCL line, of the master device to a General Purpose Input Output (GPIO) mode; informing the slave device to release the SDA line by sending a release signal from the SCL pin of the master device; and setting the I2C bus to a START condition by the master device.

In an embodiment, the sending of the release signal from the SCL pin of the master device comprises sending a plurality of consecutive clock pulses from the SCL pin of the master device to the slave device via the SCL line of the I2C bus and then setting the SCL line to a high level.

In an embodiment, the sending of the plurality of consecutive clock pulses comprises sending at least nine consecutive clock pulses.

In an embodiment, the setting of the I2C bus to the START condition comprises pulling the SDA line from a high level down to a low level while the SCL line is at a high level.

In an embodiment, the initialization method further comprises setting, by the slave device, the SDA line to a high level after receiving the release signal to release the SDA line.

In an embodiment, the initialization method further comprises, before informing the slave device to release the SDA line, determining if the SDA line is at a high level and, if so, omitting the informing step.

In an embodiment, the initialization method further comprises: monitoring the SDA line and stopping the informing step and proceeding to set the I2C bus to the START condition if the SDA line switches to a high level.

According to a second aspect of the present disclosure, there is provided a master device adaptive for communicating with a slave device via an I2C bus comprising a serial clock (SCL) line and a serial data (SDA) line. The master device comprises: an SCL pin configured to transmit clock signals; an SDA pin configured to transmit and/or receive data signals; an SCL control unit configured to control output of the SCL pin; an SCL mode management unit configured to set a mode of the SCL pin; and an SDA control unit configured to control output of the SDA pin. During initialization of the I2C system, the SCL mode management unit configures the SCL pin to a GPIO mode. Then the SCL control unit controls the SCL pin to output a release signal to inform the slave device to release the SDA line. After the SDA line is released, the SDA control unit and the SCL control unit cooperate to set the SCL and SDA pins to a START condition.

In an embodiment, the release signal comprises a plurality of consecutive clock pulses followed by a high level.

In an embodiment, the plurality of consecutive clock pulses comprise at least nine consecutive clock pulses.

In an embodiment, the START condition comprises a transition of the SDA pin from a high level to a low level of the SDA pin while the SCL pin is at a high level.

In an embodiment, the slave device sets the SDA line to a high level to release the SDA line.

In an embodiment, the master device further comprises an SDA monitoring unit configured to, before the SCL control unit controlling the SCL pin to output the release signal, determine if the SDA pin is at a high level. If the SDA monitoring unit determines the SDA pin is at the high level, the SCL control unit and the SDA control unit cooperate to set the SCL and SDA pins to the START condition without outputting the release signal.

In an embodiment, the master device further comprises an SDA monitoring unit configured to, during the SCL control unit controlling the SCL pin to output the release signal, determine if the SDA pin is at a high level. The SCL control unit may further be configured to control the SCL pin to stop outputting the release signals and cooperate with the SDA control unit to set the SCL and SDA pins to the START condition if the SDA pin is at the high level.

According to a third aspect of the present disclosure, there is provided a computer program comprising program code instructions executable by a processor for implementing the steps of a method according to the first aspect of the disclosure.

According to a fourth aspect of the present disclosure, there is provided Computer program product which is stored on a non-transitory computer readable medium and comprises program code instructions executable by a processor for implementing the steps of a method according to the first aspect of the disclosure.

### BRIEF DESCRIPTION OF THE DRAWINGS

The above and other objects, features, and advantages of the present disclosure will become apparent from the following descriptions on embodiments of the present disclosure with reference to the drawings, in which:

FIG. 1 is a block diaphragm schematically showing an exemplary structure of an I2C system.

FIG. 2 schematically shows an exemplary communication process between a master device and a slave device in the I2C system shown in FIG. 1.

FIG. 3 schematically shows an initialization process from abnormal termination in an I2C system according to an embodiment of the present disclosure.

FIG. 4 is a flow chart schematically showing an initialization method in an I2C system according to an embodiment of the present disclosure.

FIG. 5 is a flow chart schematically showing an initialization method in an I2C system according to an embodiment of the present disclosure.

FIG. 6 schematically shows an initialization process from abnormal termination in an I2C system according to an embodiment of the present disclosure.

FIG. 7 is a flow chart showing an initialization method in an I2C system according to an embodiment of the present disclosure.

FIG. 8 is a block diagram schematically showing a master device according to an embodiment of the present disclosure as well as its connection to a slave device via an I2C bus.

In the drawings, similar or same steps and/or elements are designated with similar or same referential numbers. It is to be noted that not all the steps and/or elements shown in the drawings are necessary for some embodiments of the present disclosure. For simplicity and clarity, those optional steps and/or elements are shown in dashed lines.

### DETAILED DESCRIPTION OF EMBODIMENTS

In the discussion that follows, specific details of particular embodiments of the present techniques are set forth for purposes of explanation and not limitation. It will be appreciated by those skilled in the art that other embodiments may be employed apart from these specific details. Furthermore, in some instances detailed descriptions of well-known methods, nodes, interfaces, circuits, and devices are omitted so as not obscure the description with unnecessary details.

Those skilled in the art will appreciate that the functions described may be implemented in one or several units. Some or all of the functions described may be implemented using hardware circuitry, such as analog and/or discrete logic gates interconnected to perform a specialized function, ASICs, PLAs, etc. Likewise, some or all of the functions may be implemented using software programs and data in conjunction with one or more digital microprocessors or general purpose computers. Moreover, the technology can additionally be considered to be embodied entirely within any form of computer-readable memory, including non-transitory embodiments such as solid-state memory, magnetic disk, or optical disk containing an appropriate set of computer instructions that would cause a processor to carry out the techniques described herein.

Hardware implementations of the presently disclosed techniques may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

Next, specific embodiments will be explained in detail with reference to accompanying drawings.

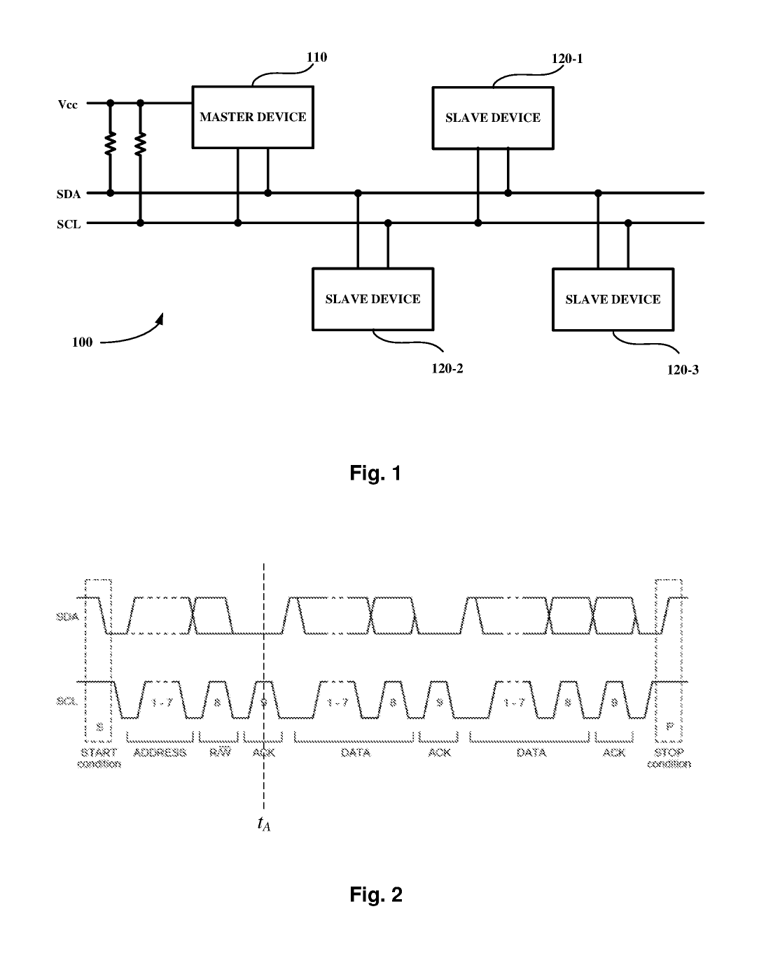

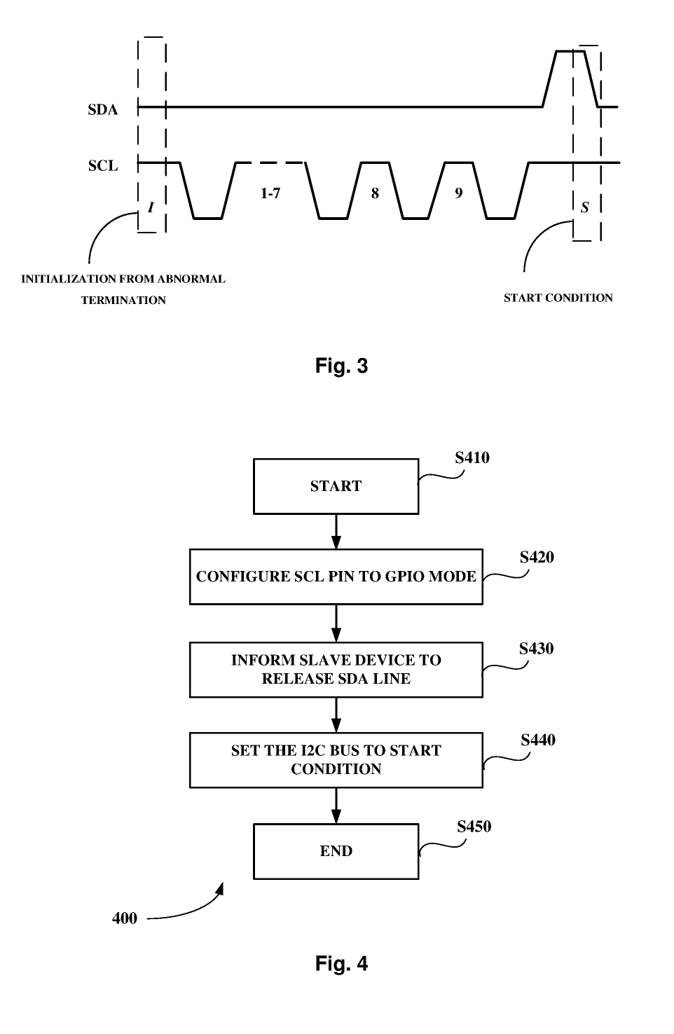

FIG. 3 schematically shows an initialization process from abnormal termination in an I2C system according to an embodiment of the present disclosure. The I2C system may have a structure similar to that shown in FIG. 1 except that the master and slave devices are adapted according to the present disclosure. As shown in FIG. 3, communication between the master device and the slave device in the I2C system is terminated abnormally by, e.g., accidental power down or malfunction of the master device, leaving the SDA line at an unreleased state, e.g., a low level. Upon initialization from this abnormal termination state, the master device first configures its SCL pin to a GPIO mode and then outputs a release signal from the SCL pin to the slave device via the SCL line. In an embodiment of the present disclosure, the release signal comprises a plurality of (e.g., at least nine) clock pulses followed by a high level. In response to the release signal, the slave device leases the SDA line, e.g., by setting it to a high level. Then the I2C system can be initialized as normal by pulling down the SDA line from the high level to a low level while the SCL line is at the high level.

FIG. 4 is a flow chart schematically showing an initialization method 400 in an I2C system according to an embodiment of the present disclosure. The I2C system may have a structure similar to that shown in FIG. 1 except that the master and slave devices are adapted according to the present disclosure. The method begins in step S410. In step S420, the master device configures its SCL pin to a GPIO mode. In step S430, the master device informs the slave device to release the SDA line by sending a release signal from the SCL pin of the master device to the slave device via the SCL line. In an embodiment of the present disclosure, the release signal may comprise a plurality of consecutive clock pulses followed by a high level. In an embodiment of the present disclosure, the plurality of clock pulses may comprise at least nine pulses. In step S440, the master device sets the I2C bus to a START condition by, e.g., pulling the SDA line down from a high level to a low level while the SCL line is at a high level. Then the method ends in step S450.

In an embodiment of the present disclosure, the method may further comprise, after the start of step S430 and before step S440, the slave device releasing the SDA line by setting it to the high level in response to the release signal. It should be noted that it is not necessary for the slave device to release the SDA line after it receives the complete release signal. Instead, the slave device may release the SDA line after it receives a part of the release signal, e.g., after it receives one, two, three, . . . , or nine clock pulses of the release signal.

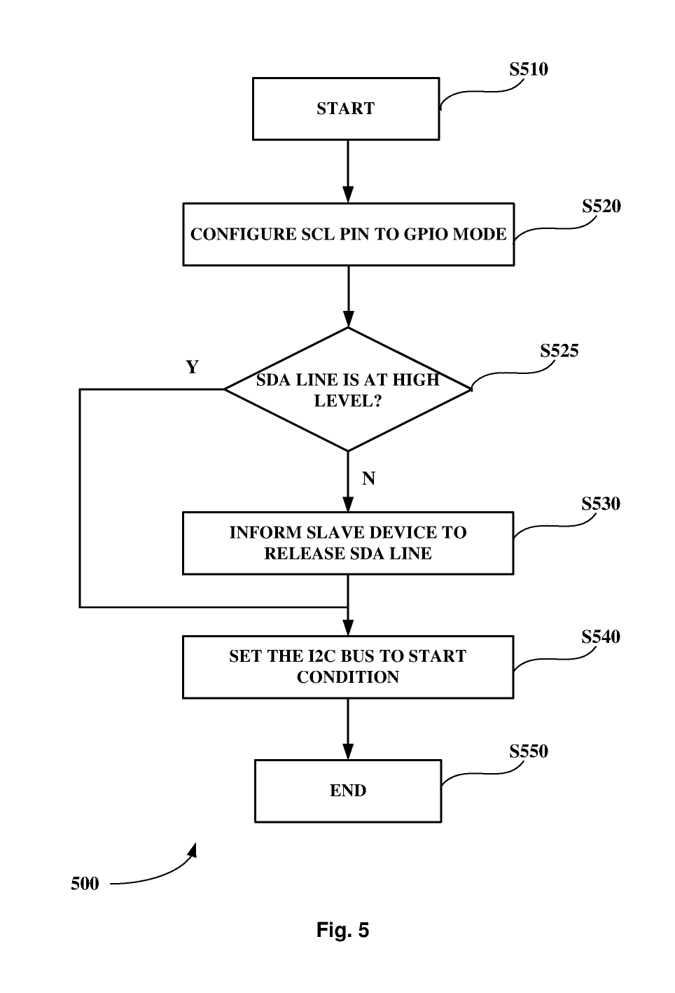

FIG. 5 is a flow chart schematically showing an initialization method 500 in an I2C system according to an embodiment of the present disclosure. The I2C system may have a structure similar to that shown in FIG. 1 except that the master and slave devices are adapted according to the present disclosure. The method begins in step S510. In step S520, the master device configures its SCL pin to a GPIO mode. In step S525, the master device determines if the SDA line is already at a high level. If the SDA line is at the high level, the method proceeds to step S540. Otherwise, the method proceeds to step S530, where the master device informs the slave device to release the SDA line by sending a release signal from the SCL pin of the master device to the slave device via the SCL line. In an embodiment of the present disclosure, the release signal may comprise a plurality of consecutive clock pulses followed by a high level. In an embodiment of the present disclosure, the plurality of clock pulses may comprise at least nine pulses. In step S540, the master device sets the I2C bus to a START condition by, e.g., pulling the SDA line down from a high level to a low level while the SCL line is at a high level. Then the method ends in step S550.

In an embodiment of the present disclosure, the method may further comprise, after the start of step S530 and before step S540, the slave device releasing the SDA line by setting it to the high level in response to the release signal. It should be noted that it is not necessary for the slave device to release the SDA line after it receives the complete release signal. Instead, the slave device may release the SDA line after it receives a part of the release signal, e.g., after it receives one, two, three, . . . , or nine clock pulses of the release signal.

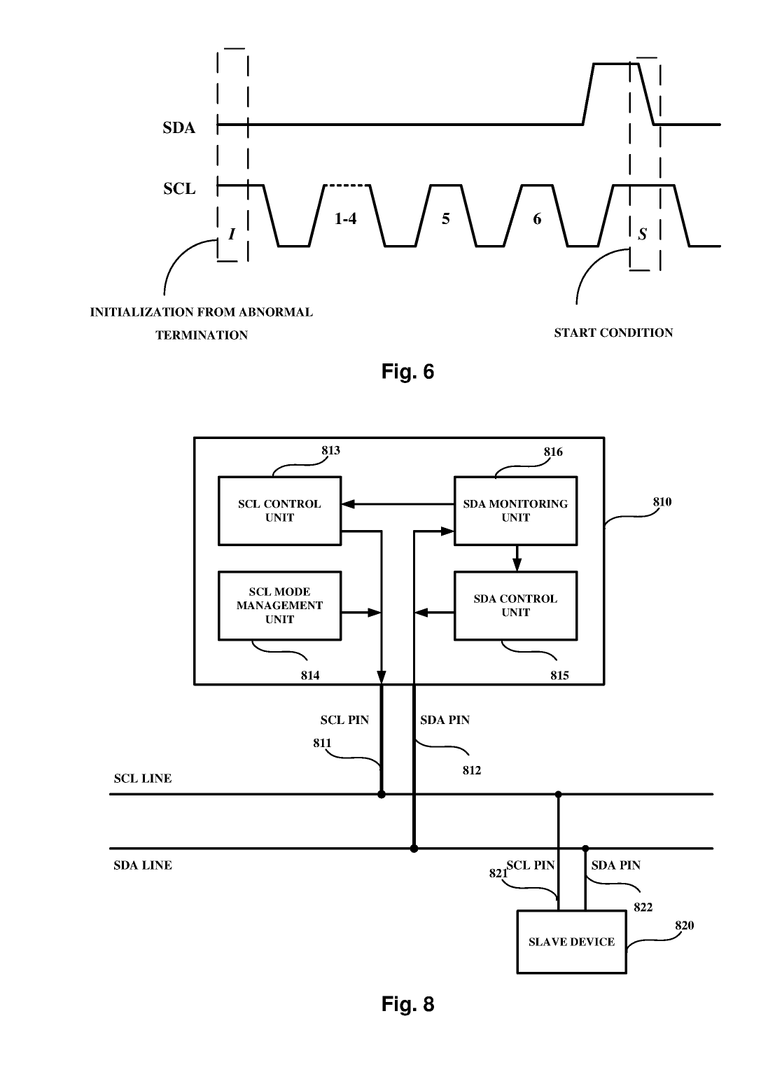

FIG. 6 schematically shows an initialization process from abnormal termination in an I2C system according to an embodiment of the present disclosure. The I2C system may have a structure similar to that shown in FIG. 1 except that the master and slave devices are adapted according to the present disclosure. As shown in FIG. 6, communication between the master device and the slave device in the I2C system is terminated abnormally by, e.g., accidental power down or malfunction of the master device, leaving the SDA line at an unreleased state, e.g., a low level. Upon initialization from this abnormal termination state, the master device first configures its SCL pin to a GPIO mode and then outputs a release signal from the SCL pin to the slave device via the SCL line. In an embodiment of the present disclosure, the release signal comprises a plurality of (e.g., at least nine) clock pulses followed by a high level. During the release signal, the master device monitors the SDA line and stops transmitting the release signal once the SDA line is released, e.g., switches to a high level. Then the master device sets the SCL line to a high level and I2C system can be initialized as normal by pulling down the SDA line from the high level to a low level while the SCL line is at the high level.

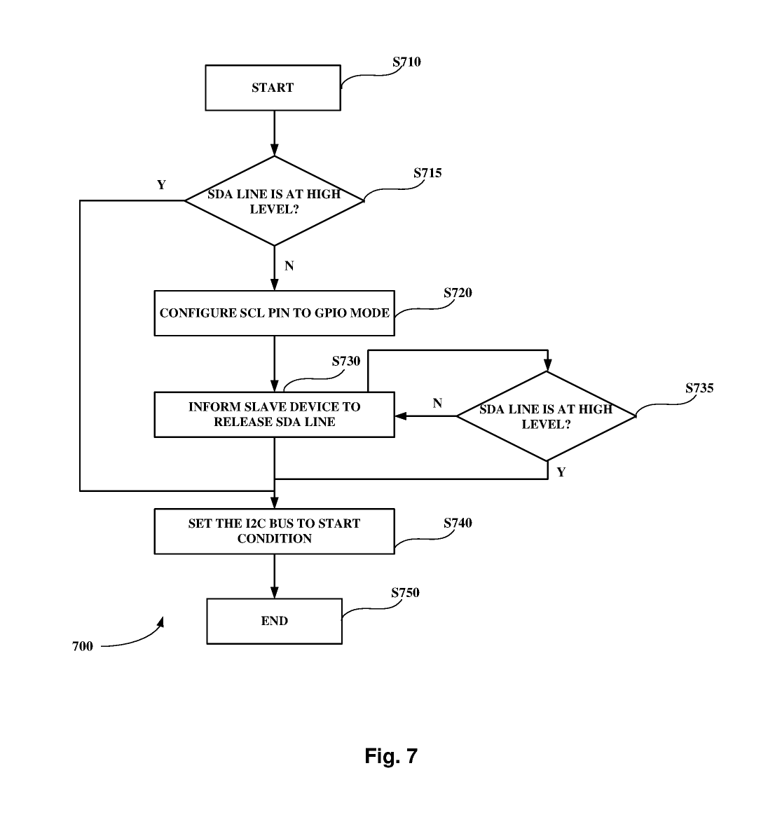

FIG. 7 is a flow chart schematically showing an initialization method 700 in an I2C system according to an embodiment of the present disclosure. The I2C system may have a structure similar to that shown in FIG. 1 except that the master and slave devices are adapted according to the present disclosure. The method begins in step S710. In step S720, the master device configures its SCL pin to a GPIO mode. In step S730, the master device informs the slave device to release the SDA line by sending a release signal from the SCL pin of the master device to the slave device via the SCL line. In an embodiment of the present disclosure, the release signal may comprise a plurality of consecutive clock pulses followed by a high level. In an embodiment of the present disclosure, the plurality of clock pulses may comprise at least nine pulses. While the master device is sending the release signal, the master device monitors the SDA line in step S735 to determine if it is released, e.g., by switching to a high level. If it is determined that the SDA line is released in step S735, the method proceed to step S740. Otherwise the master device continues to send the release signal until the complete signal is sent. In step S740, the master device sets the I2C bus to a START condition by, e.g., pulling the SDA line down from a high level to a low level while the SCL line is at a high level. Then the method ends in step S750.

In an embodiment of the present disclosure, the method may further comprise, after the start of step S730 and before step S740, the slave device releasing the SDA line by setting it to the high level in response to the release signal. It should be noted that it is not necessary for the slave device to release the SDA line after it receives the complete release signal. Instead, the slave device may release the SDA line after it receives a part of the release signal, e.g., after it receives one, two, three, . . . , or nine clock pulses of the release signal.

It should be noted that, in the foregoing description, although various steps are described in separate embodiments, these steps can be combined to achieve additional benefits. Furthermore, more steps can be added to and some steps can be omitted from the above-described methods, if applicable. Also, the order for performing the stepson can be varied as necessary. All such variations and modifications fall within the scope of the present disclosure as long as the principle of the present disclosure can be properly carried out.

FIG. 8 is a block diagram schematically showing a master device 810 according to an embodiment of the present disclosure as well as its connection to a slave device 820 via an I2C bus. As shown in FIG. 8, the master device 810 comprises an SCL pin 811, an SDA pin 812, an SCL control unit 813, an SCL mode management unit 814, and an SDA control unit 815. The SCL pin 811 is connected to an SCL line of the I2C bus and is configured to transmit clock signals to the slave device 820 through the SCL line. The SDA pin 812 is connected to an SDA line of the I2C bus and is configured to transmit and/or receive data signals to/from the slave device 820 via the SDA line. The SCL control unit 813 is configured to control the output of the SCL pin 811. The SCL mode management unit 814 is configured to set a mode of the SCL pin 811. The SDA control unit 815 is configured to control the output of the SDA pin 812. The slave device 820 is connected to the I2C bus by its SCL pin 821 and SDA pin 822.

During initialization of the I2C system, the SCL mode management unit 814 configures the SCL pin 811 to a GPIO mode. Then the SCL control unit 813 controls the SCL pin 811 to output a release signal to inform the slave device 820 to release the SDA line. In an embodiment of the present disclosure, the release signal may comprise a plurality of consecutive clock pulses followed by a high level. In an embodiment of the present disclosure, the plurality of consecutive clock pulses may comprise nine pulses. The slave device 820 releases the SDA line by, e.g., setting it to a high level in response to the release signal. In an embodiment of the present disclosure, the slave device 820 may release the SDA line after it receives a part of the release signal, e.g., after it receives one, two, three, . . . , or nine clock pulses of the release signal. After the SDA line is released, the SCL control unit 813 and the SDA control unit 815 cooperate to set the SCL pin 811 and the SDA pin 812 to a START condition. In an embodiment of the present disclosure, the START condition of the SCL pin 811 and the SDA pin 812 may comprise a transition of the SDA pin from a high level to a low level while the SCL pin is at the high level. After that, communication between the master device 810 and the slave device 820 can be performed as normal.

In an embodiment of the present disclosure, the master device 810 may further comprise a SDA monitoring unit 816 configured to monitor a state of the SDA pin 812. The SDA monitoring unit 816 may determine, at the beginning of the initialization process, if the SDA pin is already at the high level. If the SDA pin is already at the high level, the SCL control unit 813 will not send the release signal. Instead, the SCL control unit 813 cooperates with the SDA control unit 815 to set the SCL pin 811 and the SDA pin 812 to the START condition. Otherwise, if the SDA monitoring unit 816 determines that the SDA pin 812 is not at the high level, the SCL control unit 813 starts to send the release signal as described above. This may effectively reduce time delay in the initialization process because if the SDA pin 812 is already at the high level before the initialization process, the master device 810 can perform the initialization process as normal directly without having to let the slave device 820 to set the SDA line to the high level.

In an embodiment of the present disclosure, if the SDA monitoring unit 816 determines, at the beginning of the initialization process, that the SDA pin is not at the high level, the SCL control unit 813 starts to send the release signal as described above. During the time interval of the release signal, the SDA monitoring unit 816 continues to monitor the SDA pin 812 and the SCL control unit 813 stops the release signal once the SDA monitoring unit 816 determines that the SDA pin 812 switches from a low level to the high level. Then the SCL control unit 813 and the SDA control unit 815 cooperate to set the SCL pin 811 and the SDA pin 812 to the START condition. This can also reduce the time delay in the initialization process because if the slave device 820 releases the SDA line after receiving only a part of the release signal, it is not necessary to send the remaining part of the release signal.

The present disclosure can be applied to various I2C systems to improve the initialization process after abnormal termination of communication between a master device and a slave device. By informing the slave device to release the SDA line before entering the START condition the I2C system can be initialized properly without having to redo the power cycle of the slave device. This can greatly improve customer experience especially in the I2C system involving user interaction, e.g., in a home I2C system. For example, in the home I2C system comprising a Set Top Box (STB) as the master device and an HDMI television (HDMI TV) as the slave device, when communication therebetween is interrupted due to accidental power down or malfunction of the STB, the user does not have to restart both the HDMI TV and the STB to continue the TV program he/she is just viewing. Instead, what he/she needs to do is only to restart the STB. This is much more convenient for the user and the user's experience can be greatly improved because he/she does not have to tolerate the boring time necessary for the restart of the HDMI TV.

Also, according to the present disclosure, as the improvement to the existing I2C system is mostly at the master device, it is not necessary to change the existing slave device. This makes the present disclosure particularly compatible with the existing I2C system and easy to implement with low cost.

The above embodiments of the present disclosure can be implemented at least partly as hardware circuits. For example, the embodiments of the present disclosure can be implemented by a processor. The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

In an embodiment of the present disclosure, there is provided a computer-readable storage medium storing instructions that when executed, cause one or more computing devices to perform the method according to the present disclosure.

Although the present technology has been described above with reference to specific embodiments, it is not intended to be limited to the specific form set forth herein. The technology is limited only by the accompanying claims and other embodiments than the specific above are equally possible within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

The present disclosure has been described above with reference to embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached.

1. An initialization method for use in an Inter-Integrated Circuit (I2C) system, the I2C system comprising at least a first device and a second device, which are interconnected via an I2C bus comprising a serial clock (SCL) line and a serial data (SDA) line, the method comprising:
informing the second device to release the SDA line by sending a release signal from an SCL pin which is connected to the SCL line of the first device after a configuration of the SCL pin of the first device to a General Purpose Input Output (GIPO) mode is made; and
setting the I2C bus to a START condition by the first device.

2. The initialization method according to claim 1, wherein:
said sending the release signal from the SCL pin of the first device comprises sending a plurality of consecutive clock pulses from the SCL pin of the first device to the second device via the SCL line of the I2C bus and then setting the SCL line to a high level.

3. The initialization method according to claim 2, wherein said sending the plurality of consecutive clock pulses comprises sending at least nine consecutive clock pulses.

4. The initialization method according to claim 1, wherein:
said setting the I2C bus to the START condition comprises pulling the SDA line from a high level down to a low level while the SCL line is at a high level.

5. The initialization method according to claim 1, further comprising:
setting, by the second device, the SDA line to a high level after receiving the release signal to release the SDA line.

6. The initialization method according to claim 1, further comprising, before informing the second device to release the SDA line:
determining if the SDA line is at a high level and, if so, omitting the informing step.

7. The initialization method according to claim 1, further comprising:
monitoring the SDA line; and
stopping the informing step and proceeding to set the I2C bus to the START condition if the SDA line switches to a high level.

8. A first device adaptive for communicating with a second device via an Inter-Integrated Circuit (I2C) bus comprising a serial clock (SCL) line and a serial data (SDA) line, comprising:
an SCL pin configured to transmit clock signals;
an SDA pin configured to transmit and/or receive data signals;
an SCL control unit configured to control output of the SCL pin;
an SCL mode management unit configured to set a mode of the SCL pin; and
an SDA control unit configured to control output of the SDA pin, wherein, during initialization of the I2C system:
the SCL mode management unit configures the SCL pin to a General Purpose Input Output (GPIO) mode;
the SCL control unit controls the SCL pin to output a release signal to inform the second device to release the SDA line; and
the SDA control unit and the SCL control unit cooperate to set the SCL and SDA pins to a START condition.

9. The first device according to claim 8,
wherein the release signal comprises a plurality of consecutive clock pulses followed by a high level.

10. The first device according to claim 9, wherein the plurality of consecutive clock pulses comprises at least nine consecutive clock pulses.

11. The first device according to claim 10, wherein the START condition comprises a transition of the SDA pin from a high level to a low level of the SDA pin while the SCL pin is at a high level.

12. The first device according to claim 8, wherein the SDA line is released upon the SDA line being set to a high level by the second device.

13. The first device according to claim 8, further comprising:
an SDA monitoring unit configured to, before the SCL control unit controlling the SCL pin to output the release signal, determine if the SDA pin is at a high level,
wherein if the SDA monitoring unit determines the SDA pin is at the high level, the SCL control unit and the SDA control unit cooperate to set the SCL and SDA pins to the START condition without outputting the release signal.

14. The first device according to claim 8, further comprising:
an SDA monitoring unit configured to, during the SCL control unit outputting the release signal, determine if the SDA pin is at a high level,
wherein the SCL control unit is further configured to control the SCL pin to stop outputting the release signals and cooperate with the SDA control unit to set the SCL and SDA pins to the START condition if the SDA pin is at the high level.
